(19) United States
(12) Patent Application Publication
(10) Pub. No.: US 2010/0031198 A1
(43) Pub. Date: Feb. 4, 2010

(54) Data-Oriented User Interface for Mobile Device

(76) Inventors: Michael Zimmerman, Sammamish, WA (US); Philip A. Rogan, Seattle, WA (US); Ned Dykstra Hayes, Olympia, WA (US); Edward Ross Witus, Seattle, WA (US); Patrick James Ferrel, Seattle, WA (US); Jonathan D. Lazarus, Mercer Island, WA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/512,854

(22) Filed: Jul. 30, 2009

Related U.S. Application Data
(60) Provisional application No. 61/137,620, filed on Jul. 30, 2008.
(60) Provisional application No. 61/142,879, filed on Jan. 6, 2009.

(51) Int. Cl. G06F 3/048

(52) U.S. Cl. 715/853

(57) ABSTRACT

A user interface for a mobile device allows users to interact across applications with information relevant to known people, organizations, or locations, referred to herein as “recognized entities.” Every type of recognized entity has associated action options that populate a node menu for that type. The node menu options are selectable, for example, through a touchscreen interface, to rapidly execute the associated action. In another embodiment, a plurality of data windows, referred to as “spinners,” are viewed simultaneously on one display. Each spinner is a view of one or more data objects provided that are distinguished from one another by data type, context, parsing or sorting algorithms, or user interaction with this data. The spinners respond to user actions, to new information from the server, or external events by automatically visibly scrolling the data displayed in the spinner windows.

### CROSS-REFERENCE TO RELATED APPLICATION

This application claims the benefit of U.S. Provisional Patent Application No. 61/137,620, filed Jul. 30, 2008, and U.S. Provisional Patent Application No. 61/142,879, filed Jan. 6, 2009, which are hereby incorporated by reference in their entirety. This application is related to U.S. patent application Ser. No. ______, filed Jul. 30, 2009 entitled “Social Network Model for Semantic Processing,” which is also incorporated by reference in its entirety.

### BACKGROUND

1. Field of the Invention

The present invention relates to a user interface for a mobile device.

2. Description of the Related Art

Data can inherently be useful in a variety of applications across different contexts. However, most data stored on or accessed by mobile devices are organized according to the context presented on a screen within a single application, and it is cumbersome to interact with the data outside of the context in which it appears. In order to take action on data outside of the data's original context, the data must be copied and placed into the appropriate context from which the action can be launched. For example, a user may be viewing an email from a work colleague in an email browser and want to quickly check the details of an upcoming meeting with that same colleague stored in a calendar application. As a result, the user has to switch contexts from the email browser to the calendar application, and execute a search for meetings with the colleague, for example, by retyping or cutting and pasting in the colleagues' name into a search interface for the calendar application.

The hassles of carrying data across contexts in order to interact with the data are exacerbated by the limited screen size of most mobile devices. A small screen size limits the amount of information that can be viewed at one time, thus making it more difficult to take action through mobile devices.

### SUMMARY

Embodiments of the invention provide a user interface for a mobile device that allows users to interact across applications with information relevant to known people, organizations, or locations, referred to herein as “recognized entities.” In one embodiment, recognized entities are identified or selected from displayed data. Each recognized entity has a type. Every type of recognized entity has associated action options that populate a node menu for that type. The node menu options are selectable to rapidly execute the associated action. Selections of node menu options can be achieved through a variety of mechanisms used in computers and mobile devices. Mechanisms can include, but are not limited to, touchscreen interfaces, touchpads, directional pointing devices, voice controlled interfaces, hardware keyboard shortcuts, directional hardware keys and hardware elements such as wheels and rolling balls. In another embodiment, a plurality of data windows, referred to as “spinners,” are viewed simultaneously side-by-side on one display. A single spinner is a view of one or more data objects provided by a source. A plurality of spinners provides a user the ability to view data from multiple sources at once. The spinners respond to user actions, such as the selection of a particular data object from any of the spinners, or external events, such as an incoming phone call or arrival at a particular location by automatically and visibly updating the data displayed in the spinner windows.

### BRIEF DESCRIPTION OF THE DRAWINGS

FIG. 1 is a high-level block diagram of the computing environment in accordance with an embodiment of the invention.

FIG. 2 is a block diagram of a server, in accordance with an embodiment of the invention.

FIG. 3 is a block diagram of a mobile device, in accordance with an embodiment of the invention.

FIG. 4 is a high-level block diagram illustrating an example of a computer for use as a mobile device or server, in accordance with an embodiment of the invention.

FIG. 5 is an illustration of a mobile device displaying an email message, in accordance with an embodiment of the invention.

FIG. 6 is an illustration of a mobile device displaying an email message having recognized entities highlighted, in accordance with an embodiment of the invention.

FIG. 7A is an illustration of the mobile device displaying a node menu relevant to a selected entity, in accordance with an embodiment of the invention.

FIG. 7B is an expanded illustration of the node menu relevant to the selected entity illustrated in FIG. 7A.

FIG. 7C is an expanded illustration of a node menu that allows a selection between available entities, in accordance with an embodiment of the invention.

FIG. 8 is a flowchart illustrating an example method of executing a contextual action from a node menu, in accordance with an embodiment of the invention.

FIG. 9 is an illustration of an example user interface of a device displaying a plurality of windows associated with different applications, in accordance with an embodiment of the invention.

FIG. 10 is an illustration of a user interface of a device wherein the plurality of windows have scrolled to display data relevant to a recognized entity, in accordance with an embodiment of the invention.

FIG. 11 is a flowchart illustrating an example method of displaying data relevant to a recognized entity in a plurality of windows, in accordance with an embodiment of the invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

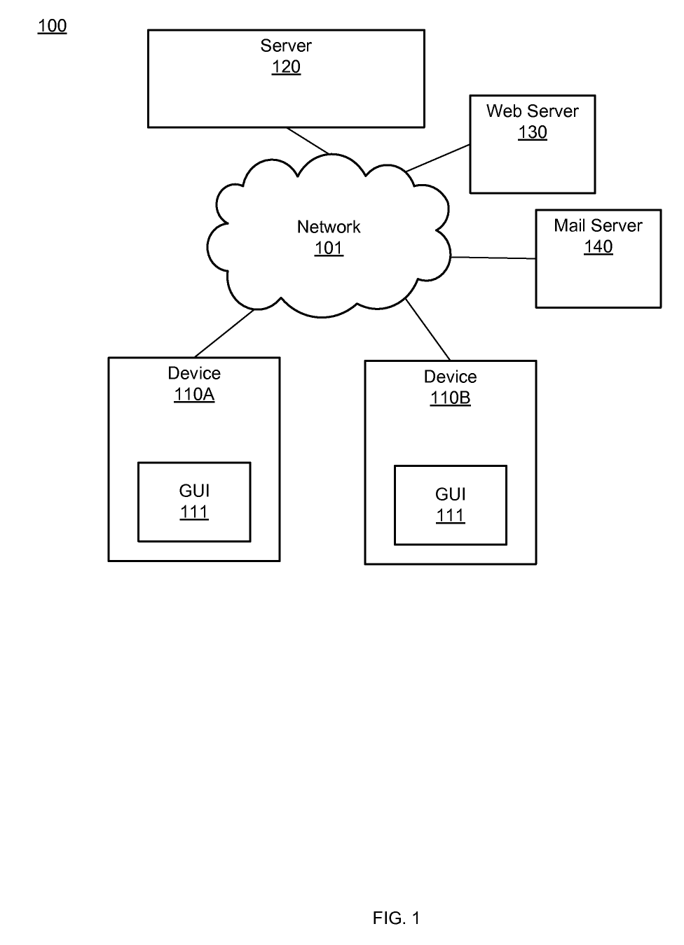

FIG. 1 is a high-level block diagram of the computing environment 100 in accordance with an embodiment of the invention. The computing environment 100 includes a server 120 that is connected via a network 101 to a plurality of devices 110A, 110B, each having a graphical user interface (“GUI”) 111. The network 101 is a communications network such as a local area network, a wide area network, a wireless network, an intranet, or the Internet. In one embodiment, the computing environment 100 also includes a web server 130 and a mail server 140 which provide content to the devices 110A, 110B. Although only two devices 110A, 110B, and a limited number of servers are shown in FIG. 1 for clarity, any number and type of devices and server configurations may be connected to the network 101.

In one embodiment, devices 110A, 110B are mobile devices such as smart phones, that offer broad functionality. For example, the mobile device may send and receive text messages and email, offer web access, provide GPS functionality, manage contact information, track calendar appointments, and manage and communicate other types of documents and data. The devices 110A, 110B receive data, documents, and messages from the server 120 or from other servers such as web server 130 and mail server 140 located on the network 101. The devices 110A, 110B also send data, documents, and messages, for example via server 120, to other locations on the network 101.

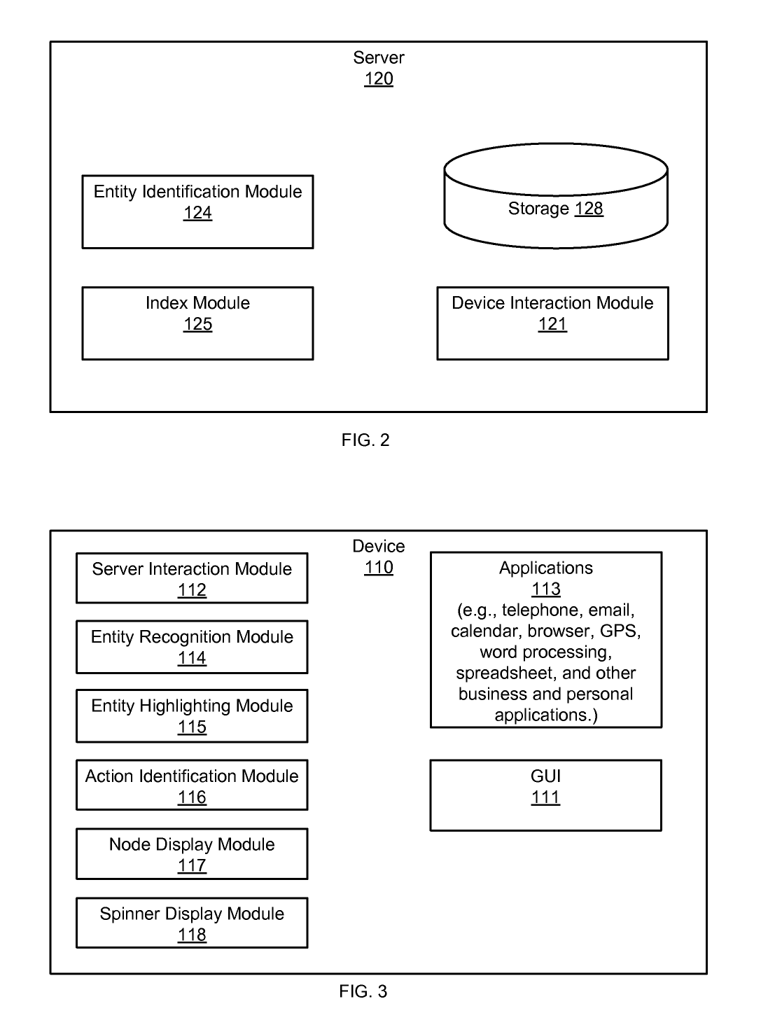

FIG. 2 is a block diagram of a server 120, in accordance with an embodiment of the invention. The server 120 primarily serves data, metadata, documents, files, and other content, for example from web server 130 or mail server 140, to the devices 110 that are also connected to the network 101. The server 120 can also receive data, metadata, documents, and files from the devices 110 for subsequent processing. In this example, the server 120 includes an entity identification module 124, an index module 125, a device interaction module 121, and a local storage 128.

The entity identification module 124 identifies entities from data and metadata to be sent to a device 110A, 110B or received from the device 110A, 110B for subsequent processing. The entity identification module 124 parses text to identify textual strings including, but not limited to the following: location names, names of people, names of organizations, dates, times, phone numbers, email addresses, names of items and identifying words commonly used by the user, and uniform resource locators for online content (Web site URLs) according to algorithms known to those of skill in the art. For example, a corpus-trained extraction module detects references to people, locations, and organizations based on algorithms derived from the training corpus. A rule-based system recognizes dates and times. A collection of regular expressions is used for phone numbers, email addresses, and uniform resource locators (URLs).

The index module 125 indexes the data and metadata, for example, according to the identified entities from those documents. In cases where a document or file contains more than one identified entity, the document or file may be indexed under each identified entity. The index module 125 may store the results of the indexing in a local storage 128 or remote storage (not shown).

The device interaction module 121 manages the communications between the server 120 and the devices 110A, 110B. Specifically, the device interaction module 121 receives data and metadata from, for example, web server 130 and mail server 140 or other locations on the network 101 to be sent to a device 110A, 110B, including, in one embodiment, metadata identifying entities within the data, documents, and files from the entity identification module 124. The device interaction module 121 also receives data, metadata, documents, and files sent from devices 110A, 110B to the server 120 for subsequent processing, retrieval and searches against this data.

FIG. 3 is a block diagram of a device 110 as one example of the devices 110A, 110B shown in FIG. 1, in accordance with an embodiment of the invention. In various embodiments, the device 110 may be any device capable of communicating over the network 101. Examples of a device 110 include a personal digital assistant (PDA) device, a mobile phone device with telephony interfaces, an advanced mobile phone device with telephony and computer interfaces, a computer with limited external user interfaces (such as a television set-top box or in-store computer kiosk), a portable computer with multiple external interfaces (such as a laptop), and a stationary computer with multiple external interfaces (such as a desktop personal computer). In this example, in addition to the graphical user interface 111, the device 110 also includes a server interaction module 112, an entity recognition module 114, an entity highlighting module 115, an action identification module 116, a node display module 117, various applications 113, and a spinner display module 118.

The graphical user interface 111 of the device 110 provides users with a data-oriented environment to interact with the data accessed on the device 110. The graphical user interface 111 allows users to view information and select information, for example, by clicking on it, touching it, highlighting it with a cursor, or any other method of selecting a portion of the displayed information. The graphical user interface 111 includes node menus that contain actions relevant to a selected entity. The graphical user interface 111 also includes spinners which allow a user to simultaneously view information from a variety of applications that is relevant to an entity. The node menus and spinners will be described in greater detail below.

The server interaction module 112 manages the communications between the server 120 and the device 110. The server interaction module 112 receives data, metadata, documents, and files sent to the device 110 from the server 120, including, in one embodiment, metadata identifying entities within the data, documents, and files. The server interaction module 112 is the device counterpart to the device interaction module 121 of the server 120. The server interaction module 112 also receives data, metadata, documents, and files to be sent to the server 120 from the device 110.

The entity recognition module 114 recognizes entities in the data received, and/or displayed on the device 110. The entity recognition module 114 parses the text of any data, documents, or files, to identify entities. In some cases, as discussed above, the entities may have already been identified by the entity identification module 124 of the server 120, and the identification of the entities is communicated through metadata associated with the data, documents, and files. In one embodiment, the entity recognition module 114 may compare data received and/or displayed to lists of recognized entities known to the user of the device 110. In one embodiment, the recognition of entities is performed using the semantic processing and social network models described in co-pending U.S. patent application Ser. No. ______, filed Jul. 30, 2009 entitled “Social Network Model for Semantic Processing,” which has been incorporated herein by reference. The entity recognition module 114 may also index received data according to recognized entities and store the index either locally or remotely. The entity recognition module 114 may also recognize entities instead of or in addition to the entities communicated to the device 110 through metadata from the server 120.

The entity highlighting module 115 highlights recognized entities within the user interface 111. For example, the entity highlighting module 115 may format the text of a recognized entity name in a different font, different color, or different text effect. In one embodiment, the entity highlighting module 115 creates a screen overlay that darkens or lightens for a few moments all parts of the display except for the recognized entity names. Thus, the visibility of words other than the recognized entities is momentarily reduced. The screen overlay then fades away, and the recognized entity names may thereafter be surrounded by a faint highlight background color to identify for the user that they are recognized entity names. Any other technique of emphasizing or showing text or icons in a distinguishing manner can be used additionally or alternatively.

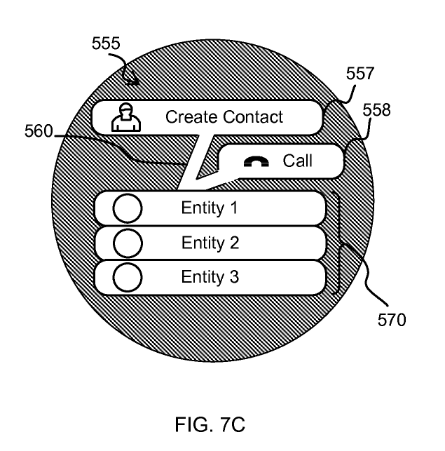

In one embodiment, performing entity recognition may result in more than one entity corresponding to the same portion of text. In these cases, the entity highlighting module 115 may provide an interface element 570, shown in FIG. 7C, that enables the user to select from among the available entities. In the variation shown in FIG. 7C, a list of the available entities is simultaneously displayed. In another variation, element 570 instead provides a one-by-one display of each of the recognized entities in sequence, from which a user can choose a preferred entity. When the preferred entity is chosen by the user, this invokes the action identification module 116.

The action identification module 116 identifies actions that are relevant to a recognized entity. These actions may be dynamically generated based on context, including but not limited to such factors as what data sources are available on the computing device, the recognized entity from which the action originated, user activity, user preferences and tracked behavior, GPS-position of the device, proximity of other computing devices and network bandwidth available at the time of activity. Generally, the actions that are relevant to a recognized entity depend on the type of the identified entity. Whereas certain actions are relevant to people, such as calling them, emailing them, and scheduling a meeting with them, other actions may be relevant to location entities, such as mapping the location, viewing appointments scheduled for the location, and so forth. The identified actions comprise options for how the user may interact with the data, as will be described in greater detail below.

In one embodiment, a user can interact with the actions in order to modify which actions display. In one embodiment, for different entity types, the user may select a set of action options to display with respect to people, a set of action options to display with respect to organizations, and a set of action options to display with respect to locations. The sets of action options for each of these types of entities need not be the same. In one embodiment, the layout of the node menu may be responsive to observed patterns in a user's behavior with respect to action options that have been previously presented in node menus. For example, a user may frequently select the action item for emailing a person entity. Thus, the action option for emailing the particular person entity may be presented more prominently or favorably located than the other action options, such as displaying it first, closest of the action options to the top and/or left of the display, highlighted or presented using any other technique designed to draw attention to the option. Alternatively or additionally, the option for emailing any person entity may also be displayed more prominently or favorably located than the other options for the respective people entities.

The action identification module 116 also chooses actions based on computer interface capabilities and information available in the storage module 128 which is accessible by the device 110. In one embodiment, if the device has telephony capabilities and there is a phone number indexed to that entity in the storage module 128, then action identification module 116 provides the capability to call the person identified by the recognized entity. The action identification module 116 also chooses actions based on context, such as time of day, the location of the device, and current calendar events scheduled for the user. The action identification module 116 also chooses actions based on learned behavior, such as whether or not the user ever uses telephony or messaging services, and which services are most commonly used by the user of the device. In one embodiment, if the user never uses a particular action that is provided by action identification module 116, over time the action identification module 116 will substitute a more commonly used action for that unused action.

The node display module 117 displays UI elements that contain appropriate actions identified by the action identification module 116. One embodiment of this node display module 117 is a search UI element that supports a node menu that allows a user to choose search filter options, or a node menu from a specific entity that allows a user to choose a specific action, as shown in FIG. 7B. The node display module 117 may format the UI elements, including any node menus or UI elements elsewhere on the screen and determines the layout and visual presentation of those UI elements to be displayed on the device 110. In one embodiment, the layout of the node menu is responsive to user preferences for the types of action options to display.

The device 110 also includes various applications 113 that provide various functionality to the device 110. For example, the applications 113 may comprise a telephone, email, calendar, browser, GPS, word processing, spreadsheet, and other business and personal applications that allow a user to input data and metadata and files to the storage 128 or modify data and metadata and files already existing in storage 128. The applications 113 may receive data, metadata, documents and files over the network 101. In one implementation, the actions that a user may take with respect to an entity are tied to one or more of the applications 113 that provide functionality to the device 110.

The spinner display module 118 displays on one screen a plurality of windows, referred to herein as “spinners.” Each spinner has a respective set of associated data that may or may not overlap with the respective set of data associated with another spinner. The respective sets of associated data may be distinguished from one another by data type, context, parsing or sorting algorithms, or user interaction with the data. Each spinner displays a distinct view of at least a portion of the data set associated with it. For example, each window may contain data originating from a different application of the applications 113. As another example, each window may contain data from a different context, including but not limited to contexts defined by factors such as what data sources are available on the device 110 and/or any combination of filters applied to the data to filter the data, for example, by attributes. Various data associated with one spinner is linked to various data associated with another spinner. For example, some of the data associated with a first and second spinner relates to the same entity. As another example, some of the data associated with a first and second spinner have the same attribute or characteristic.

The spinner display module 118 controls the appearance of the spinners. For example, the spinner display module 118 controls the format of the spinners and the display of data within the window. In one embodiment, the spinner display module 118 also controls the apparent motion of the spinners as data scrolls up and down within the windows. In this example embodiment, the spinners “spin” in response to user actions, such as selecting a particular object in any of the spinner windows, or external events, such as the receipt of an incoming phone call, email, arrival at a particular location, or new information from the server 120. An embodiment of the invention shows scrolling of the text up and down within a window to give the illusion that the data within the window has been placed on the curved surface of a cylinder that is rotating around a horizontal axis. The spinner display module 118 may control the motion of multiple spinners that spin at the same time to synchronize the display of data among the spinners relevant to an entity or having the same attribute or characteristic, as will be described in more detail below. In other embodiments, the spinners are replaced with the simultaneous display of other types of windows or divisions in the UI to display data with or without simulated motion. For example, the data could appear in a visual form that resembles stacks of tiles that shuffle, or as individual images of cards in a virtual roll-a-dex.

The spinner display module 118 may format a spinner display as a result of a search. For example, a first spinner may show the results of a first search, and a second window may show the results of a subset of the information from the first window. For example, a user has list of inbox items which is the result of a search for all available data objects that arrived in the last hour, and share a common flag such as “unread.” A user selects a data object from the list within a first window. A second window on the same display, seen simultaneously with the first window, is then populated with a list of data items that are linked to the selected data object, for example by arriving in the same time period and containing information which also references the same entity.

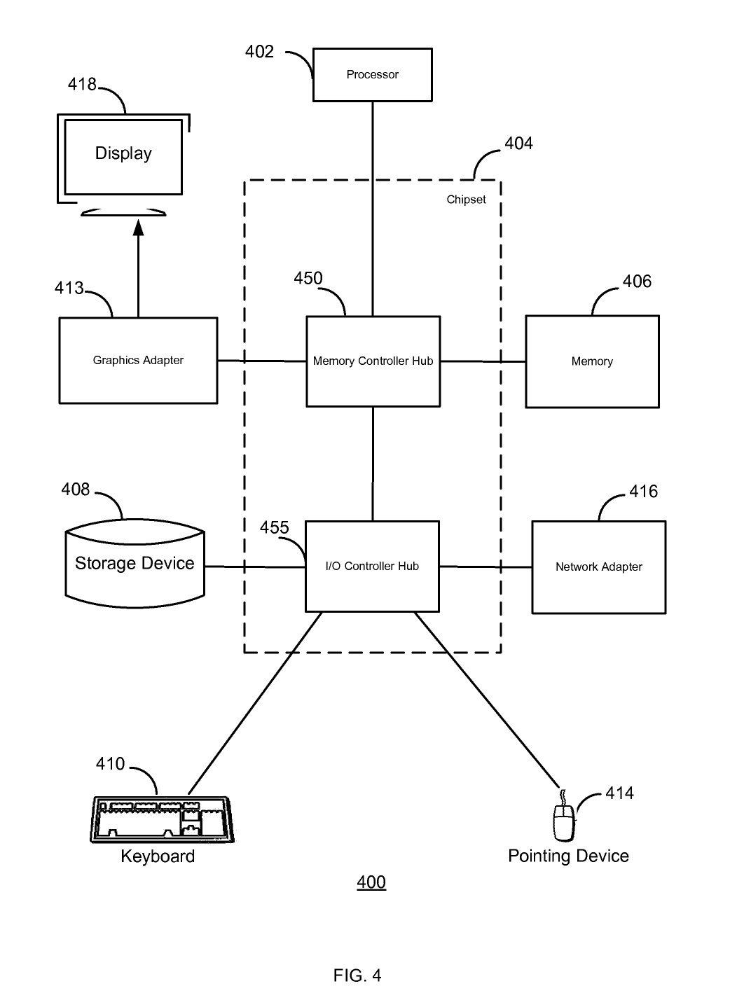

FIG. 4 is a high-level block diagram illustrating an example of a computer 400 for use as a server 120 or device 110, in accordance with an embodiment of the invention. Illustrated are at least one processor 402 coupled to a chipset 404. The chipset 404 includes a memory controller hub 450 and an input/output (I/O) controller hub 455. A memory 406 and a graphics adapter 413 are coupled to the memory controller hub 450, and a display device 418 is coupled to the graphics adapter 413. A storage device 408, keyboard 410, pointing device 414, and network adapter 416 are coupled to the I/O controller hub 455. Other embodiments of the computer 400 have different architectures. For example, the memory 406 is directly coupled to the processor 402 in some embodiments.

The storage device 408 is a computer-readable storage medium such as a hard drive, compact disk read-only memory (CD-ROM), DVD, or a solid-state memory device. The memory 406 holds instructions and data used by the processor 402. The pointing device 414 is used in combination with the keyboard 410 to input data into the computer system 400. Mechanisms used to convey user input can include, but are not limited to, touchscreen interfaces, touchpads, directional pointing devices, voice controlled interfaces, hardware keyboard shortcuts, directional hardware keys and hardware elements such as wheels and rolling balls. The graphics adapter 413 displays images and other information on the display device 418. In some embodiments, the display device 418 includes a touch screen capability for receiving user input and selections. The network adapter 416 couples the computer system 400 to the communications network 101. Some embodiments of the computer 400 have different and/or other components than those shown in FIG. 4.

The computer 400 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 408, loaded into the memory 406, and executed by the processor 402.

The types of computers 400 used by the entities of FIG. 1 can vary depending upon the embodiment and the processing power used by the entity. For example, a mobile device 110 that is PDA typically has limited processing power, a small display 418, and might lack a pointing device 414. The server 120, in contrast, may comprise multiple blade servers working together to provide the functionality described herein.

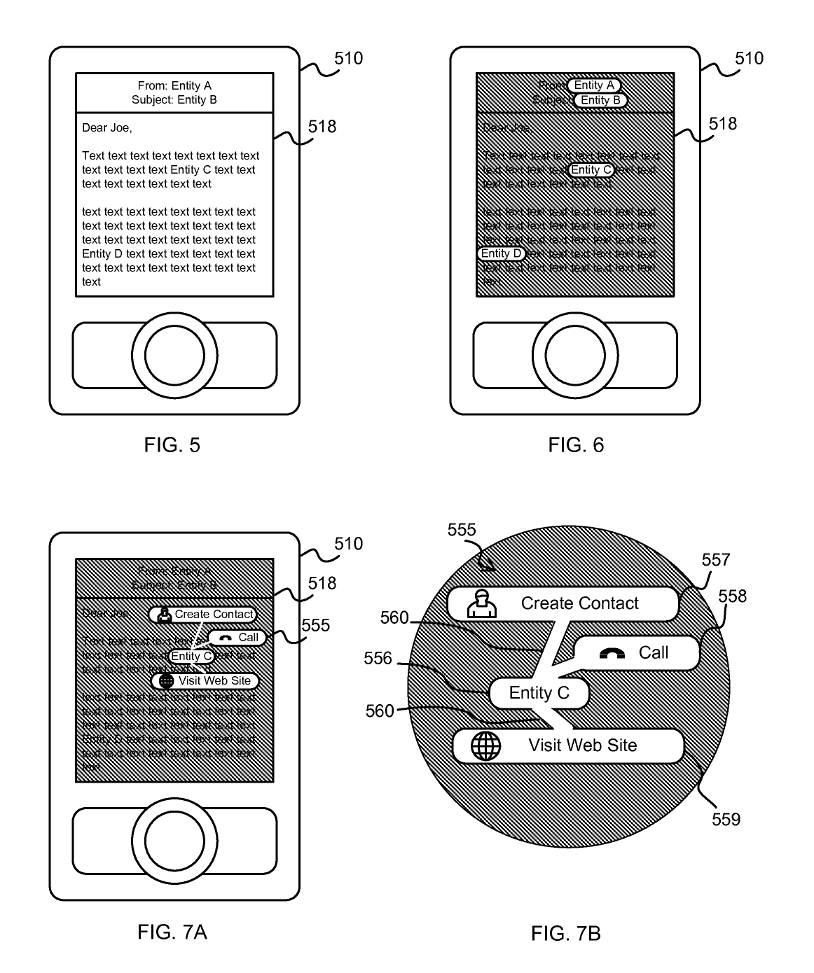

FIG. 5 is an illustration of a mobile device 510 displaying an email message on its screen 518, in accordance with an embodiment of the invention. In this example, the mobile device 510 includes an email application as one of the applications 113. As shown in FIG. 5, the names of several entities, including entity A, entity B, entity C, and entity D are displayed on the screen 518 in connection with the email. The entities may be the names of people, organizations, or locations, for example.

FIG. 6 is an illustration of a mobile device displaying an email message having recognized entities highlighted, in accordance with an embodiment of the invention. In this example, the names of entity A, entity B, entity C, and entity D are highlighted while the remainder of the screen 518 is brightened or darkened momentarily, with the appearance of having an opaque or translucent layer overlaid on the screen everywhere except for around the entity names, so as to emphasize the entity names. In one embodiment, after displaying the highlighted entity names along with opaque remainder of the screen, the display returns to normal, for example, as pictured in FIG. 5. In one variation, the darker shading fades from view, and the entity names are displayed on a lightly colored background immediately surrounding each entity name. This opaque or translucent background serves to distinguish entity names from ordinary text, so as to signal to the user which words are entity names. In other examples, the format of the text of a recognized entity name may be in a different font, different color, or different text effect. Any other technique of emphasizing or showing text or icons in a distinguishing manner can be used additionally or alternatively.

FIG. 7A is an illustration of the mobile device displaying a node menu 555 relevant to a selected entity, in accordance with an embodiment of the invention. In this example, the user has selected entity C. Once an entity is selected, a node menu 555 is displayed. The node menu 555 contains options for actions that a user may want to take with respect to the selected entity. In one embodiment, the node menu does not display an action as an option if the information needed to undertake the action is not available on the device. For example, the action option of calling the entity will not appear if the entity's phone number is not known. The node menu 555 is well adapted for the small screens of mobile devices because it allows users to select possible actions to take with respect to a selected entity, for example, through applications 113, without the hassles of repeated context shifts between applications to identify possible actions. In the example illustrated in FIG. 7A, the action options include creating a new contact, calling the entity, or visiting the entity's web site.

FIG. 7B is an expanded illustration of the node menu 555 relevant to the selected Entity C illustrated in FIG. 7A. A central node, referred to as an anchor node 556, surrounds the text of the selected entity name, in this case “Entity C,” and has edges 560 radiating outward and connecting to nodes representing action items 557, 558, and 559. The length of the edges 560 radiating outward to connect to other nodes and the placement of the other nodes may be responsive to the screen size of the device 510 and where the anchor node 556 appears on the screen. For example, if the selected entity appears in the text at the top left corner of the screen, the other nodes may be connected to the bottom and right sides of the anchor node 556 in order to be visible to the user. Optionally, the nodes representing action items 557, 558, and 559 may contain text and/or an icon representing the action. In one embodiment, the action options appear to blossom out of the entity node name, and the remainder of the screen darkens while awaiting the user's selection of an action from the node menu 555. In one embodiment, an action option is only displayed if the information relevant to the recognized entity with respect to the action is known. In one embodiment, the node menu 555 contains up to six action options. If more than six action options are available for display, the sixth option may be an option to view the remainder of the options. In this case, the sixth option may be labeled “More” or another appropriate indicator that more action options are available if the option is selected. If the user selects the sixth option, the remaining action options may appear in simple list displayed on the display 418 of the device 510 or in another node menu that branches out from the sixth option, for example.

FIG. 7C illustrates a user interface element 570, as previously discussed, that allows a user to select among entities that were found during entity recognition to correspond to the same portion of text, in accordance with one embodiment of the invention. In this example, the user may select from Entity 1, Entity 2, and Entity 3 from the user interface element 570. In the variation shown in FIG. 7C, a list of the available entities is simultaneously displayed. In another variation, element 570 instead provides a one-by-one display of each of the recognized entities in sequence, from which a user can choose a preferred entity.

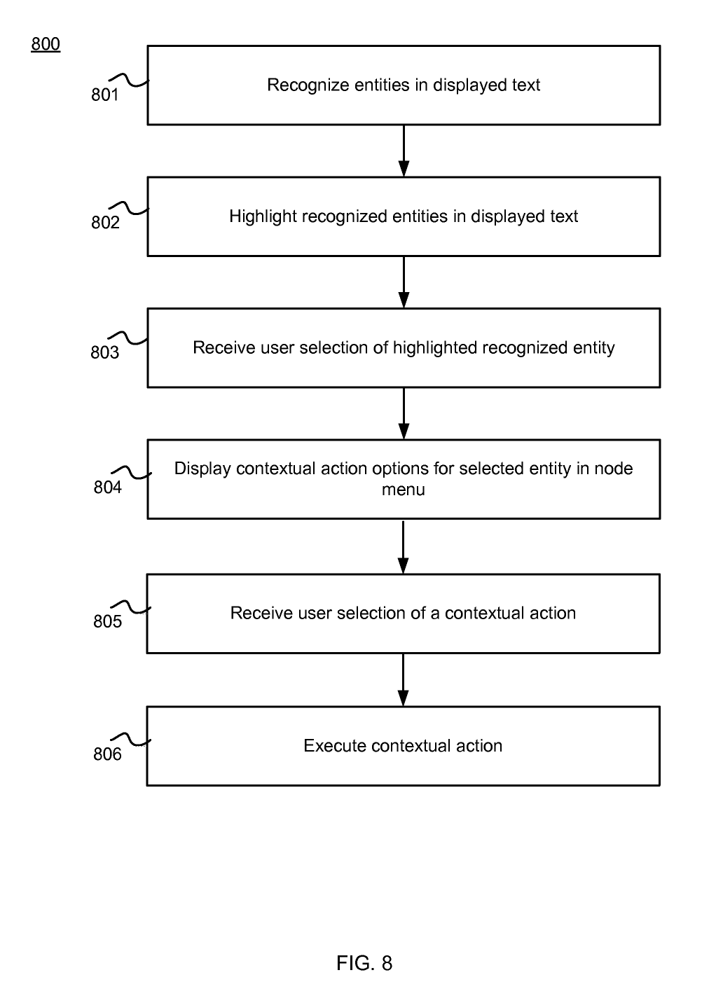

FIG. 8 is a flowchart illustrating an example method 800 of executing a contextual action from a node menu, in accordance with an embodiment. In step 801, the names of entities within displayed text are recognized. In one embodiment, the entity recognition module on the device 110 performs the entity recognition. In another embodiment, the entity identification module 124 of the server 120 identifies the entities and passes them to the device 110 via the device interaction module 121.

In step 802, the recognized entities are highlighted in the displayed text. In one embodiment, the entity highlighting module 115 may format the text of a recognized entity name in a different font, different color, or different text effect. In one embodiment, the entity highlighting module 115 creates a screen overlay that brightens or darkens for a few moments all parts of the display except for the recognized entity names. The screen overlay then fades away, and the recognized entity names may thereafter be surrounded by a faint highlight background color to identify for the user that they are recognized entity names. Any other technique of emphasizing or showing text or icons in a distinguishing manner can be used additionally or alternatively.

In step 803, a user selection of a highlighted recognized entity is received. Then, in step 804, contextual action options for a selected entity are displayed for the user on the screen in a node menu. These contextual actions may have been previously generated by the system, or may be dynamically generated at the time of the user selection of a recognized entity. In either case, they are exposed to the user in step 804, when the user selects a highlighted recognized entity. These actions may be dynamically generated based on context, including such factors as what data sources are available on the computing device, recognized entity from which the action originated, user activity, user preferences and tracked behavior, GPS-position of the device, proximity of other computing devices and network bandwidth available at the time of activity. In one embodiment, an action option is only displayed if the information relevant to the recognized entity with respect to the contextual action is known and available. For example, an action option of calling the entity will not appear if the entity's phone number is not known. As another example, an action option for visiting a web site will not appear if the entity's web site is not known. Generally, the actions that are relevant to a recognized entity depend on the type of the identified entity. Whereas certain actions are relevant to people, such as calling them, emailing them, and scheduling a meeting with them, other actions may be relevant to location entities, such as mapping the location, viewing appointments scheduled for the location, and so forth. The identified actions comprise options for how the user may interact with the data, for example, through the applications 113 on the device 110.

In step 805, a user selection of a contextual action is received. Then, in step 806, the device 110 executes the contextual action selected by the user. For example, if the user selects “call” from the node menu 555, the entity's phone number is dialed by the telephone application of the device 110. If the user selects “visit web site” from the node menu 555, then the entity's web site address is entered into a browser application of the device 110. If the user selects “create new contact”, then the information known about the entity is used to populate a contact card in a contacts application of the device 110. Thus, the user is able to quickly view and execute contextual actions across applications 113 on the device 110 with respect to recognized entities.

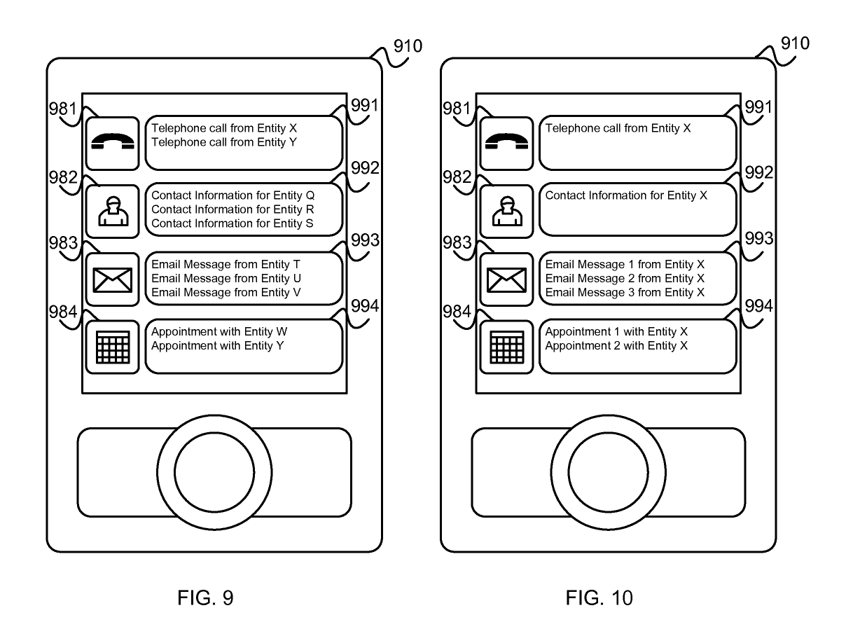

FIG. 9 is an illustration of an example graphical user interface 111 of a device 910 such as device 110, displaying a plurality of windows 991, 992, 993, 994. In this example, each window is associated with different applications 113, in accordance with an embodiment of the invention. In one embodiment, each window 991, 992, 993, 994 is marked by a different icon 981, 982, 983, 984 to indicate the type of application associated with the data in the windows 991, 992, 993, 994. FIG. 9 illustrates one example configuration of four windows each containing data from one respective application. Any number of windows from two up to as many as can simultaneously be displayed on the display of the device 110 may be included in the graphical user interface 111. Other configurations including other positions and orders of windows and applications, as well other types of applications may be included in respective windows. The default organization of the data within the windows may be user configurable in terms of what types of data are displayed to represent the underlying data from the applications as well as the order of the data objects within the list of data objects displayed in each respective window.

Each window 991, 992, 993, 994 is referred to as a “spinner.” The spinners “spin” automatically in response to user actions, such as selecting a particular object in any of the spinner windows, or external events, such as the receipt of an incoming phone call, email, arrival at a particular location, or new information received from the server 120. In one embodiment, the “spinning,” i.e., scrolling of the text up and down within a window, gives the illusion that the data within the window 991, 992, 993, 994 has been placed on the curved surface of a cylinder that is rotating around a horizontal axis.

In one embodiment, all of the data within an application is represented by data objects within a list that can be viewed in the spinner window. For example, each contact within a contact management application is represented by a data object in a list that can be viewed in the spinner window. Likewise, each appointment within a calendar application is represented by a data object in a list that can be viewed in a different spinner window. The data objects within the list can be scrolled up or down in response to a user's input. By selecting an item within a window, the application associated with that window may launch to a view of the selected item. In the example shown in FIG. 9, window 991 displays data related to a telephone application, such as phone calls received. Window 992 displays data associated with a contacts management application, such as contact information. Window 993 displays data associated with an email application, such as the title and sender of recently received emails, or other information that may typically be viewed in a user's email inbox. Window 994 displays data associated with a calendar application, such as upcoming appointments. For example, by selecting an email message within the list in window 993, the email message may open and be displayed to the user. As another example, by selecting an appointment within the list in window 994, the calendar entry corresponding to that appointment opens and is displayed to the user.

FIG. 10 is an illustration of a user interface of a device 910 wherein the plurality of windows 991, 992, 993, 994 have scrolled to display data relevant to a recognized entity, in accordance with an embodiment of the invention. In one embodiment, the data stored in the applications 113 is indexed with respect to recognized entities. In this example, the device 910 has received a new telephone call from Entity X. In one embodiment, the user selects the entry for the telephone call from Entity X, at which point the selected item is visually distinguished in order to indicate itself as the source, or originating point, of subsequent actions on the screen. After this selection point, the other windows 992, 993, 994 update to show information relevant to Entity X according to the index. Thus, the contact information for Entity X is displayed in window 992, email messages received from Entity X are displayed in window 993 and appointments with Entity X are displayed in window 994. Thus, the spinners update to automatically synchronize with respect to the Entity X. In one implementation, it is not a requirement that Entity X be referred to in any particular field or in any particular way within the indexed data objects represented by the entries in the windows 991, 992, 993, 994. For example, the most recent email messages that were sent to or from Entity X or emails that specifically reference Entity X as a recognized person entity are displayed in window 993. Likewise, calendar entries that include or specifically reference Entity X may be displayed in window 994 along with the appointments that are with Entity X. Other information unrelated to the recognized entity may or may not appear above or below the entries related to the entity within the windows.

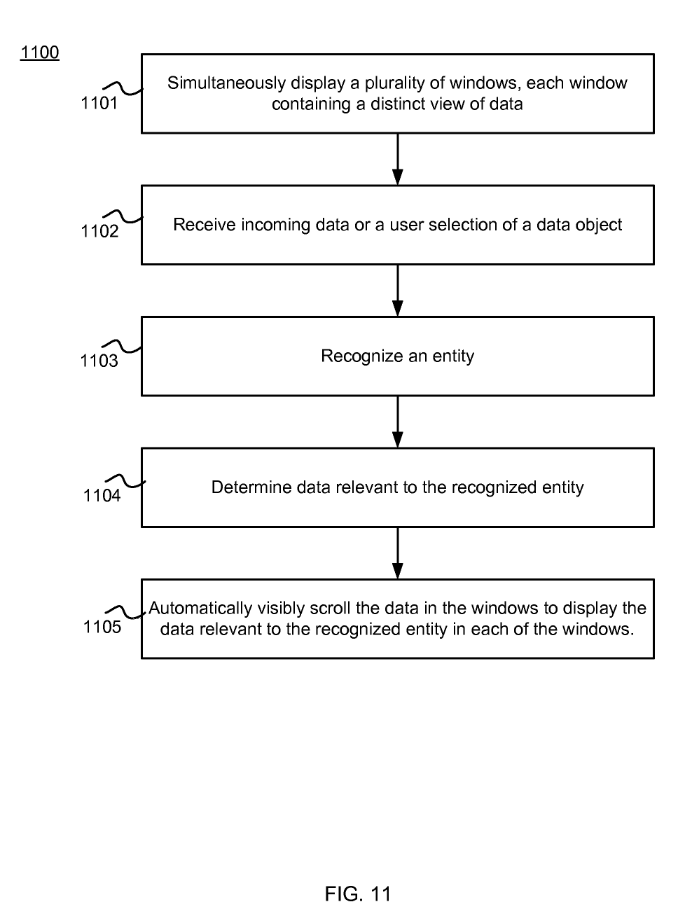

FIG. 11 is a flowchart illustrating an example method of displaying data relevant to an entity in a plurality of windows, in accordance with an embodiment of the invention. In step 1101, a plurality of windows are simultaneously displayed. Each window has a respective set of associated data that may be distinguished from one another by data type, context, parsing or sorting algorithms, or user interaction with the data. Each window displays a distinct view of at least a portion of the data set associated with it. In one embodiment, each window contains data originating from different applications, and the data has been indexed according to entity.

In step 1102, incoming data or a user selection of a data object is received. There are many diverse types of incoming data associated with different applications that may be received. For example, an email is received, a webpage is downloaded, a telephone call is received, or GPS data is received indicating the device 110 has arrived at a location of interest. Alternatively, instead of receiving incoming data associated with an application, the method may include the step of receiving a user selection of data object displayed in a window. In this case, the user may select a received email, a telephone call, an appointment, a contact, or another data object displayed within one of the spinner windows for which the user desires to view data relevant to an entity within that data object.

In step 1103, an entity in the incoming data is recognized. In the alternative case where a user selection of data associated with an application is received, an entity in the selected data is recognized. In either case, the entity recognition may be performed by the entity recognition module 114 of the device 110. For example, in a received email, the sender may be recognized as an entity. In a received phone call, the caller may be recognized as an entity. In a downloaded webpage, the organization may be recognized as an entity. In some embodiments, more than one entity is recognized. In these cases, a determination may optionally be made as to which of the recognized entities is likely to be more important to the user, for example, based on the relative amount of data indexed by those entities.

In step 1104, data relevant to the recognized entity is determined, for example, from the index that has been compiled from the data. If more than one entity is recognized in step 1103, then optionally, data associated with all the recognized entities or data associated with just the recognized entity that is determined to be likely to be more important to the user may determined from the index.

In step 1105, the data in the windows automatically visibly scrolls to display at least some of the data relevant to the recognized entity in each of the windows. For example, if the incoming data received is an email from Robert Jones, and the other applications are a contacts management application and a calendar application, where one of the entries in the contacts management application is the contact information for Robert Jones and two of the appointments in the calendar application are upcoming meetings with Robert Jones, the data in the windows associated with the contacts management application and the calendar application will automatically visible scroll either up or down until the data relevant to the recognized entity is displayed in the windows. Thus, the user is able to view data relevant to Robert Jones in the context of several applications simultaneously. By selecting a data object displayed in one of the windows, the user is able to quickly and efficiently retrieve additional information relevant to Robert Jones from any of several applications without the conventional hassles associated with context-switching between applications or views of data.

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet. Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A computer-implemented method of presenting a graphical user interface presenting actions for performing on a recognized entity, the method comprising:
displaying an anchor node representing the recognized entity;
displaying one or more action nodes representing contextual actions that can be performed on the recognized entity, wherein the one or more action nodes are adapted to execute the contextual actions responsive to user selection; and
displaying edges connecting the anchor node to each of the action nodes.

2. The method of claim 1, further comprising:
displaying the recognized entity among other text;
highlighting the displayed recognized entity and temporarily reducing visibility of the other text; and,
highlighting the displayed recognized entity and the displayed one or more action nodes, and temporarily reducing visibility of the other text.

3. The method of claim 1, wherein displaying one or more action nodes representing contextual actions that can be performed on the recognized entity is responsive to information available and relevant to the selected recognized entity.

4. The method of claim 1, wherein the contextual actions comprise actions through a plurality of different applications.

5. The method of claim 1, further comprising:
receiving a user selection of an action node representing a contextual action; and
executing the contextual action represented by the selected action node.

6. The method of claim 5, wherein executing the contextual action comprises one selected from a group of actions dynamically generated based on the selected action node, the group of actions consisting of calling a phone number, composing an email, scheduling an appointment, creating a contact, and opening a web page.

7. A computer-readable storage medium storing executable computer program instructions for presenting a graphical user interface presenting actions for performing on a recognized entity, the computer program instructions comprising instructions for:
displaying an anchor node representing the recognized entity;
displaying one or more action nodes representing contextual actions that can be performed on the recognized entity, wherein the one or more action nodes are adapted to execute the contextual actions responsive to user selection; and
displaying edges connecting the anchor node to each of the action nodes.

8. The computer-readable storage medium of claim 7, the computer program instructions further comprising instructions for:
displaying the recognized entity among other text;
highlighting the displayed recognized entity and temporarily reducing visibility of the other text; and,
highlighting the displayed recognized entity and the displayed one or more action nodes, and temporarily reducing visibility of the other text.

9. The computer-readable storage medium of claim 7, wherein displaying one or more action nodes representing contextual actions that can be performed on the recognized entity is responsive to information available and relevant to the selected recognized entity.

10. The computer-readable storage medium of claim 7, wherein the contextual actions comprise actions through a plurality of different applications.

11. The computer-readable storage medium of claim 7, the computer program instructions further comprising instructions for:
receiving a user selection of an action node representing a contextual action; and
executing the contextual action represented by the selected action node.

12. The computer-readable storage medium of claim 11, wherein executing the contextual action comprises one selected from a group of actions dynamically generated based on the selected action node, the group of actions consisting of calling a phone number, composing an email, scheduling an appointment, creating a contact, and opening a web page.

13. A computer-implemented method of simultaneously displaying data, the method comprising:
simultaneously displaying at least two windows, each window associated with a respective set of data, each window displaying a distinct view of at least a portion of the respective set of data;
receiving a user selection of data displayed in a first of the at least two windows; and
modifying the display of at least a second of the at least two windows to display data relevant to the user selection of data.

14. The method of claim 13, wherein each respective set of data originates from a different application.

15. The method of claim 13, wherein each respective set of data is distinguished by at least one from a group consisting of data type, context, parsing algorithm, sorting algorithm, and user interaction with the data.

16. The method of claim 13, wherein data relevant to the user selection of data comprises data associated with a same entity.

17. The method of claim 13, wherein data relevant to the user selection of data comprises data having a same attribute or characteristic.

18. The method of claim 13, wherein modifying the display of at least a second of the at least two windows comprises automatically visibly scrolling data in the second window to display data relevant to the user selection of data.

19. The method of claim 13, wherein the at least two windows comprise separate windows for an email application, a contact management application, a telephone application, and a calendar application.

20. The method of claim 13, wherein the at least two windows comprise separate windows for a primary search and a subset of information available in the primary search window.

21. A computer-readable storage medium storing executable computer program instructions for simultaneously displaying data, the computer program instructions comprising instructions for:
simultaneously displaying at least two windows, each window associated with a respective set of data, each window displaying a distinct view of at least a portion of the respective set of data;
receiving a user selection of data displayed in a first of the at least two windows; and
modifying the display of at least a second of the at least two windows to display data relevant to the user selection of data.

22. The computer-readable storage medium of claim 21, wherein each respective set of data originates from a different application.

23. The computer-readable storage medium of claim 21, wherein each respective set of data is distinguished by at least one from a group consisting of data type, context, parsing algorithm, sorting algorithm, and user interaction with the data.

24. The computer-readable storage medium of claim 21, wherein data relevant to the user selection of data comprises data associated with a same entity.

25. The computer-readable storage medium of claim 21, wherein data relevant to the user selection of data comprises data having a same attribute or characteristic.

26. The computer-readable storage medium of claim 21, wherein modifying the display of at least a second of the at least two windows comprises automatically visibly scrolling data in the second window to display data relevant to the user selection of data.

27. The computer-readable storage medium of claim 21, wherein the at least two windows comprise separate windows for an email application, a contact management application, a telephone application, and a calendar application.

28. The computer-readable storage medium of claim 21, wherein the at least two windows comprise separate windows for a primary search and a subset of information available in the primary search window.
